(19) United States
(12) Patent Application Publication
(10) Pub. No.: US 2016/0077668 A1
(43) Pub. Date: Mar. 17, 2016

(54) REAR PROJECTION SYSTEM WITH A FOLDABLE PROJECTION SCREEN FOR MOBILE DEVICES

(71) Applicant: THOMSON LICENSING, Issy-les-Moulineaux (FR)

(72) Inventor: Mark Alan Schultz, Billings, MO (US)

(73) Assignee: THOMSON LICENSING, Issy-les-Moulineaux (FR)

(21) Appl. No.: 14/888,614

(22) PCT Filed: May 2, 2013
(86) PCT No.: PCT/US2013/039181

§ 371 Date: Nov. 2, 2015

(51) Int. Cl. G06F 3/042; G03B 21/62; H04N 5/33; G03B 21/58

(52) U.S. Cl. CPC G06F 3/0421; G03B 21/58; G03B 21/62; H04N 5/33

(57) ABSTRACT

A rear projection system includes a screen having an expandable surface that is selectively expanded to display thereon a rear projected image illuminated by a rear pico projector. The screen is selectively contracted for enhancing portability. The rear projection system includes a foldable frame that is selectively unfolded for supporting the screen and that is selectively folded for enhancing portability. A sensor is used for converting the screen to a touchscreen when the screen surface is expanded.

### Field of the Invention

The invention relates to a portable projection screen for a video display device. In particular, the invention relates to a portable rear projection screen.

### BACKGROUND OF THE INVENTION

A pico projector is a term directed herein to a small-format hand held projector that can be used as a standalone projector or as an integrated component in hand held portable devices. The pico projector uses similar technology to that which powers a standard projector and a rear-projection television. The small size of the pico projector can be directed for use of a single viewer and can be associated with a light weight screen.

It may be desirable to include in a rear projection system a pico projector that illuminates a foldable screen installed in a foldable frame. Advantageously, rear projection system that includes a pico projector can be made to be far less sensitive than front projection system to being washed out by background lighting which can limit portable front projection system usefulness. Advantageously, the alignment of the projector of a rear projection system with respect to the screen is not critical since the user has a focus adjustment already built into the projector. With laser projection, focus would even be unnecessary.

Typically, pico projectors are designed to be front projectors. When a front projector is used in a rear projection system, the displayed image on the screen, unless corrected, would be flipped left-to-right. One solution to this image flipping problem is to use a mirror for reflecting the light produced by the projector on a rear projection screen as the target for the reflected light. Another solution is to pre-process the video signal that is applied to the pico projector by employing image reversal and rotation.

It may also be desirable to provide the foldable screen with a feature that makes it a touchscreen. For example, light sensors can be installed either in a front side of the screen, with respect to the viewer, looking for obstructions, or in a back side of the screen looking for screen displacements. Alternatively, touch sensing can be achieved remotely by using infra-red (IR) imaging from an imager or camera pointed at the back side of the screen. If the pico projector has already a built in camera assembly, additional cost of making it a touch screen might be merely that of providing an IR band pass filter and some software.

### SUMMARY OF THE INVENTION

A rear projection system, embodying an inventive feature, includes a display screen having an expandable surface that is selectively expanded to display thereon a rear projected image produced by a portable, hand held or pico projector. The display screen is selectively folded for enhancing portability. A foldable frame is selectively unfolded for supporting the screen, when the screen surface is expanded. The foldable frame is selectively folded for enhancing portability. A sensor makes the screen a touchscreen when the screen surface is expanded.

### BRIEF DESCRIPTION OF THE DRAWINGS

The preferred embodiment of the present invention will be described below in more detail with reference to the accompanying drawings in which:

FIG. 1a illustrates a side view of a rear projection system, embodying an inventive feature;

FIGS. 1b and 1c illustrate alternative ways of forming touchscreen in the arrangement of FIG. 1a;

FIG. 2 illustrates a front view of fully assembled foldable screen assembly of FIG. 1a;

FIG. 3 illustrates a front view of the foldable screen assembly of FIG. 2 in which a foldable screen is completely folded;

FIG. 4 illustrates a front view of the foldable screen assembly of FIG. 2 in which the screen is pull down approximately half way down;

FIG. 5 illustrates a front view of the foldable screen assembly of FIG. 2 in which the foldable screen is completely folded and a frame is partially folded;

FIG. 6 illustrates a front view of the foldable screen assembly of FIG. 5 in which the foldable screen is completely folded and a frame is partially folded further than in FIG. 5;

FIG. 7a illustrates a front view and FIG. 7b illustrates a side view of the foldable screen assembly of FIG. 2 in which each of the foldable screen and the frame is completely folded; and

FIGS. 8a and 8b illustrate corresponding solutions for an image flipping problem that occurs when a front projector is incorporated in the rear projection system of FIG. 1a.

### DETAILED DESCRIPTION

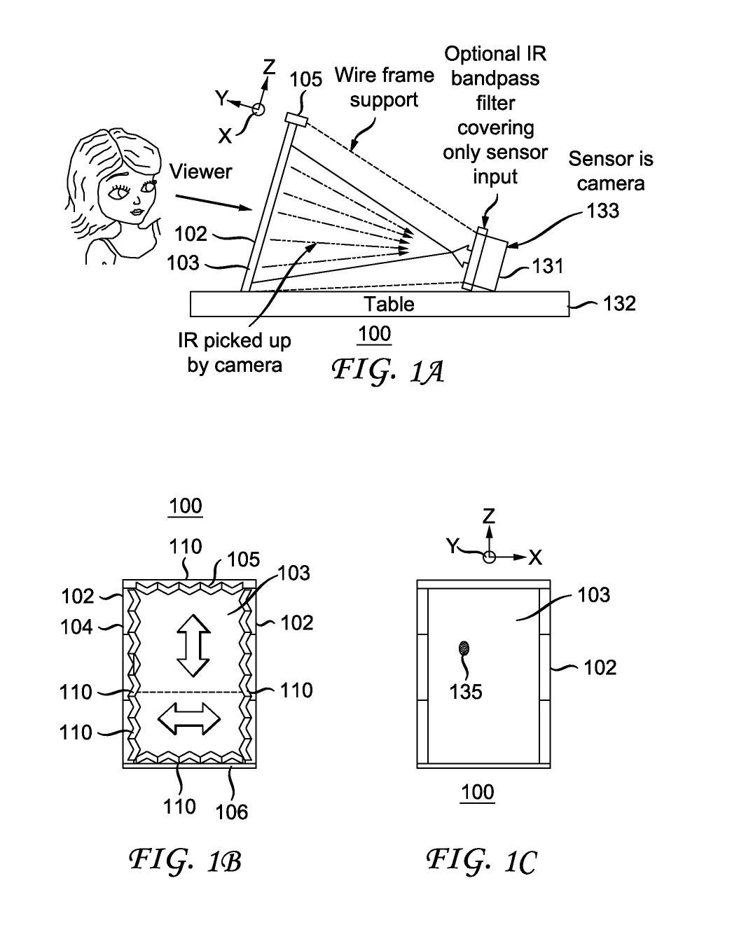

FIG. 1a illustrates a side view of foldable screen assembly 100, embodying an inventive feature. In FIG. 1a, assembly 100 is fully unfolded and ready for displaying an image, not shown. A hand held portable projector 131 that is referred to herein as pico projector 131 is mounted on a base 132 in the back of assembly 100 to form a rear projector. Pico projector 131 is driven by a video apparatus, not shown, such as a computer. Screen assembly 100 is interposed between a viewer and pico-projector 131. Selectively, screen assembly 100 can be rotated on its side to change from a letter to a landscape type display.

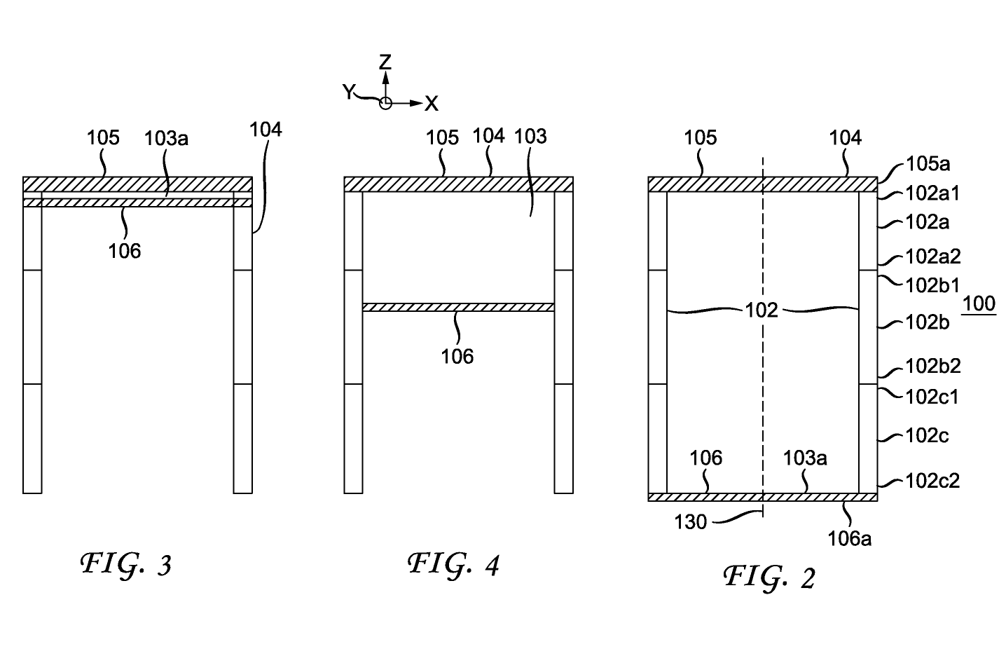

FIG. 2 illustrates a front view of foldable screen assembly 100 of FIG. 1a that includes a contractable or foldable screen 103 mounted in a rectangular foldable frame 104. In FIG. 2, assembly 100 is fully assembled, as in FIGURE la, such that each of foldable screen 103 and foldable frame 104 is completely unfolded. Similar symbols and numerals in FIGS. 1a and 2 indicate similar items or functions. In FIG. 2, constituent members or parts of foldable frame 104 are firmly locked to one another in a manner to form a rigid body that maintains its rectangular shape, as explained later on.

Foldable frame 104 includes a pair of substantially identical side portions 102 disposed at the right and left sides, respectively, of FIG. 2. An upper portion 105 of frame 104 is disposed perpendicularly to each of side portions 102 and forms a bridge type connection between portions 102. Each side portion 102 includes a tubular, top section 102a, a tubular, middle section 102b and a tubular, bottom section 102c. An upper end 102b1 of middle section 102b is rigidly fastened to a lower end 102a2 of top section 102a, when frame 104 is unfolded. A lower end 102b2 of middle section 102b is rigidly fastened to an upper end 102c1 of bottom section 102c, when frame 104 is unfolded. Upper portion 105 has a right end 105a that is rigidly fastened to a top end 102a1 of section 102a, when frame 104 is unfolded.

Screen 103 has a bottom edge 103a that is firmly attached to a lower portion 106 of frame 104. Lower portion 106 is disposed perpendicularly to each of side portions 102 and in parallel with portion 105, when frame 104 is unfolded. Lower portion 106 has a right end 106a that is rigidly fastened to a bottom end 102c2 of section 102c, when frame 104 is unfolded. This can be obtained by connecting right end 106a to bottom end 102c2 using lockable hinges, by having them fit or slide into one another or by some other suitable means. In a similar way, ends 102c1 and 102b2 can be rigidly connected to each other. The same would be applicable to the rigid connection of ends 102a2 and 102b1. Also, the same would be applicable to the rigid connection of ends 105a and 102a1.

Side portions 102, top portion 105 and bottom portion 106 of frame 104 are disposed symmetrically with respect to a longitudinal symmetry axis 130 to form the rectangular shape of frame 104. Unfolded screen 103 is disposed between the pair of side portions 102, when frame 104 is unfolded.

FIG. 3 illustrates a front view of foldable screen assembly 100 of FIG. 2 in which foldable screen 103 is completely folded and is disposed in a manner, not shown, close to upper portion 105 of frame 104. Similar symbols and numerals in FIGS. 1a, 2 and 3 indicate similar items or functions.

FIG. 4 illustrates a front view of foldable screen assembly 100 of FIG. 2 in which screen 103 is pull down approximately half way down between its completely unfolded position, shown in FIG. 2, and its completely folded position, shown in FIG. 3. Similar symbols and numerals in FIGS. 1a, 2, 3 and 4 indicate similar items or functions.

FIG. 5 illustrates a front view of foldable screen assembly 100 of FIG. 2 in which foldable screen 103 is completely folded in the same way as in FIG. 3 and frame 104 is partially folded. In FIG. 5, side portions 102 of frame 104 are partially collapsed or rotated to be no longer perpendicular to upper portion 105. Thus, the connection of end portion 105a of upper portion 105 and end portion 102a1 of side section 102a is no longer rigid and perpendicular but, instead, loose in a manner to enable the pivotal rotation of section 102a with respect to upper portion 105. Similar symbols and numerals in FIGS. 1a, 2, 3, 4 and 5 indicate similar items or functions.

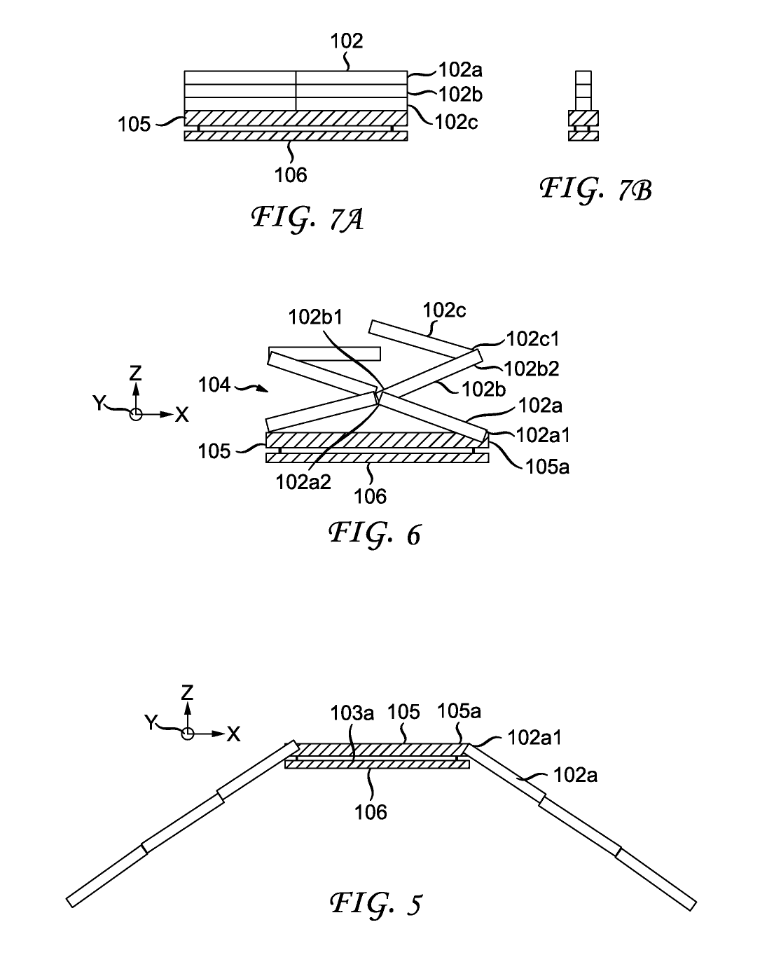

FIG. 6 illustrates a front view of foldable screen assembly 100 of FIG. 2 in which foldable screen 103 is completely folded in the same way as in FIG. 3 and frame 104 is further folded with respect to FIG. 5. In FIG. 6, each of sections 102a, 102b and 102c of side portions 102 is pivotally rotated to be on the opposite side of portion 105 with respect FIGS. 2, 3, 4 and 5. Additionally, each of sections 102a, 102b and 102c of FIG. 6 is inclined with respect to the corresponding adjacent section of portion 102. In partially folded or partially unfolded frame 104, end 102b1 of middle section 102b is no longer rigidly fastened to end 102a2 of section 102a. Instead, a junction between end 102b1 and end 102a2 forms a pivot of rotation. Similarly, a junction between end 102b2 and end 102c1 also forms a pivot of rotation. In the same way, a junction between end 102a1 and right end 105a of upper portion 105 also forms a pivot of rotation. Similar symbols and numerals in FIGS. 1a, 2, 3, 4, 5 and 6 indicate similar items or functions.

FIG. 7a illustrates a front view of foldable screen assembly 100 of FIG. 2 in which foldable screen 103 is completely folded in the same way as in FIG. 3. Additionally, frame 104 is completely folded in that each of sections 102a, 102b and 102c of each side portions 102 is rotated to be parallel disposed with respect to each of the other sections of portion 102 and with respect to portions 105 and 106. As in FIG. 6, each of sections 102a, 102b and 102c of side portions 102 is rotated to be on the opposite side of portion 105 with respect FIGS. 2, 3 and 4. FIG. 7b illustrates a side view of completely folded screen assembly 100 of FIG. 7a. Similar symbols and numerals in FIGS. 1a, 2, 3, 4, 5, 6, 7a and 7b indicate similar items or functions.

FIG. 1b illustrates a front view of system 100 of FIG. 1a. In carrying out an inventive feature, screen 103 of FIG. 1b forms a user interface touchscreen adapted to interact with a video apparatus, not shown, such as, for example, a computer or an electronic tablet. Similar symbols and numerals in FIGS. 1a, 1b, 2, 3, 4, 5, 6, 7a and 7b indicate similar items or functions.

In FIG. 1b, a corresponding part of each sensor element 110 of a series of sensor elements 110 is built into an edge of each of frame side portions 102, an edge of portion 105 and an edge portion 106. Each sensor element 110 of the series of sensor elements 110 associated with side portions 102 of frame 104 includes a light source part that is installed on, for example, left side portion 102 and a corresponding light sensor part that is installed on right side portion 102.

As long as the user/viewer does not interrupt a ray of light emitted from the light source part of sensor element 110, the light sensor part of element 110 is illuminated. On the other hand, when, for example, a finger of the user/viewer is interposed in the path of the ray of light, the light sensor part of element 110 is not illuminated. Accordingly, a vertical position Y of the finger with respect to screen 103 can be evaluated by a processor, not shown.

Similarly, each sensor element 110 of the series of sensor elements 110 associated with upper portion 105 and lower portion 106 of frame 104 includes a light source part that is installed on, for example, upper portion 105 and a corresponding light sensor part that is installed on lower portion 106. Accordingly, a horizontal position X of the finger with respect to screen 103 can be evaluated by the processor, not shown.

Sensor elements 110 may be disposed in a front of screen 103 with respect to a viewer of FIG. 1a so as to detect the aforementioned blocking of light by, for example, a finger of the user/viewer; alternatively, light sensor elements 110 of FIG. 1b may be disposed in a back of screen 103 with respect to the viewer of FIG. 1a so as to detect deflection of screen 103 when touched by the viewer. Thus, screen 103 forms a user interface touchscreen adapted to interact with a video apparatus, not shown, such as, for example, a computer or an electronic tablet that is responsive to light sensor elements 110 of FIG. 1b.

Instead of using light sensor elements 110 of FIG. 1b, a camera 133 of FIG. 1a, operating as an IR light sensor, may be combined in the same assembly with pico-projector 133. When a finger of, for example, a user/viewer touches screen 103, the touching finger sets up an abrupt change in an IR energy of a camera captured thermal image 135 that is shown in FIG. 1c. Thermal image 135 is mapped onto the pixel array, not shown, of camera 133 of FIGURE la that senses the user finger touch on screen 103. Thus, screen 103 forms a user interface touchscreen. Similar symbols and numerals in FIGS. 1a, 1b, 1c, 2, 3, 4, 5, 6, 7a and 7b indicate similar items or functions.

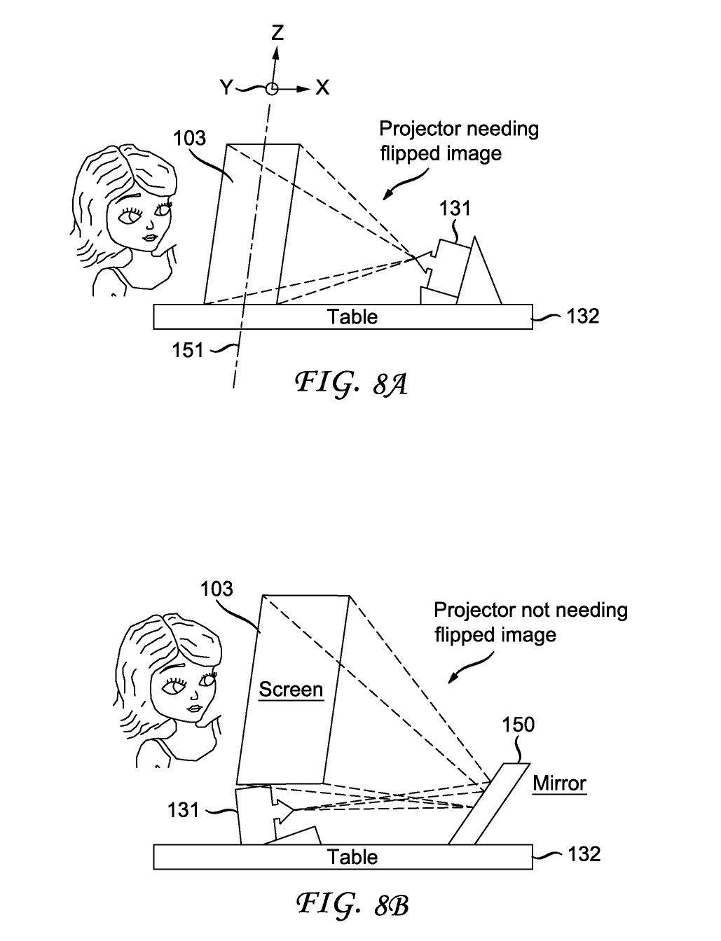

Pico projector 131 is, typically, the type designed to be used as a front projector. Without correction, pico projector 131, utilized as a rear projector such as in FIG. 1a would produce a projected image that needs image flipping correction. FIG. 8a is provided for explaining the need for such image correction and a first correction solution for such problem. FIG. 8b is provided for explaining a second correction solution for such problem. Similar symbols and numerals in FIGS. 1a, 1b, 1c, 2, 3, 4, 5, 6, 7a, 7b, 8a and 8b indicate similar items or functions.

Unlike in a front projector situation, the viewer looks into the direct light produced by projector 131, instead of at the reflected light from screen 103. Without correction, the image produced by the direct light from pico projector 131 would be improperly flipped left side-to-right side, and vice versa, with respect to an axis of symmetry 130 of FIG. 8a. In a first solution to this problem, demonstrated in FIG. 8a , an image contained in a memory, not shown, of pico projector 131 would be electronically processed by a signal processor, not shown, so as to be flipped left side-to-right side, and vice versa. In this way, the viewed image would no longer be incorrectly flipped. In an alternative solution to this problem, a mirror 150 of FIG. 8b would reflects the image to be optically flipped left side-to-right side, and vice versa, so that the viewed image would no longer be incorrectly flipped.

1. A rear projection system, comprising:
a display screen responsive to light produced by a portable, hand held or pico rear projector, said display screen having an expandable surface that is selectively expanded for displaying thereon a rear projected image and being capable of being selectively folded for enhancing portability;
a foldable frame capable of being selectively unfolded for supporting said screen, when said screen surface is expanded, and capable of being selectively folded for enhancing portability; and
an interface responsive to a user selectable position with respect to said screen for making said screen a touchscreen when said screen surface is expanded.

2. The rear projection system of claim 1 wherein said interface includes a sensor that senses blocking of a light source.

3. The rear projection system of claim 1 wherein said interface comprises a camera that can be used to form an infra-red map of an infra-red radiation emitted from said screen.

4. The rear projection system of claim 1 wherein said pico projector comprises a front projector and wherein left-right image flipping error formed by said front projector is corrected by one of a mirror and a signal processor.

5. The rear projection system of claim 1 wherein said touchscreen forms a user interface adapted to interact with a video apparatus.

6. The rear projection system of claim 1 wherein when said screen is completely folded said frame can remain partially unfolded.

7. The rear projection system of claim 1, further comprising said portable, hand held or pica rear projector.
